(19) United States
(12) Patent Application Publication
(10) Pub. No.: US 2025/0071831 A1
(43) Pub. Date: Feb. 27, 2025

(54) CLIENT DEVICE IDENTIFIER FOR DUAL-WI-FI CONNECTIONS

(71) Applicant: Cisco Technology, Inc., San Jose, CA (US)

(72) Inventors: Jerome Henry, Pittsboro, NC (US); Bart A. Brinckman, Nevele (BE); Shree Narasimha Murthy, San Jose, CA (US)

(73) Assignee: Cisco Technology, Inc., San Jose, CA (US)

(21) Appl. No.: 18/816,893

(22) Filed: Aug. 27, 2024

Related U.S. Application Data
(60) Provisional application No. 63/579,019, filed on Aug. 27, 2023.

(51) Int. Cl. H04W 76/11; H04W 76/12; H04W 76/15; H04W 84/12

(52) U.S. Cl. CPC H04W 76/11; H04W 76/12; H04W 76/15; H04W 84/12

(57) ABSTRACT

A client device identifier for dual-Wi-Fi connections may be provided. First, it may be determined that a client device has associated over a first link having a first Media Access Control (MAC) address. Next, from the client device over the first link, a first management frame may be received that identifies a MAC address of a second link associated with the client device. Then, based on information in the first management frame, it may be determined that the first link and the second link are associated with the client device.

### RELATED APPLICATION TECHNICAL FIELD

Under provisions of 35 U.S.C. § 119(e), Applicant claims the benefit of U.S. Provisional Application No. 63/579,019 filed Aug. 27, 2023, which is incorporated herein by reference.

### TECHNICAL FIELD

The present disclosure relates generally to providing a client device identifier for dual-Wi-Fi connections.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing a client device identifier for dual-Wi-Fi connections;

FIG. 2 is a flow chart of a method for providing a client device identifier for dual-Wi-Fi connections; and

FIG. 3 is a block diagram of a computing device.

### DETAILED DESCRIPTION

### Overview

A client device identifier for dual-Wi-Fi connections may be provided. First, it may be determined that a client device has associated over a first link having a first Media Access Control (MAC) address. Next, from the client device over the first link, a first management frame may be received that identifies a MAC address of a second link associated with the client device. Then, based on information in the first management frame, it may be determined that the first link and the second link are associated with the client device.

Both the foregoing overview and the following example embodiments are examples and explanatory only and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Multi-Link Operation (MLO) may comprise a client device (e.g., a station (STA)) connected with dual radios (e.g., 2.4 GHz, 5 GHz, 6 GHz) simultaneously, with the goal of increasing the available bandwidth and limiting reliance on a single point of failure. However, from the infrastructure standpoint, a dual-Wi-Fi client device may appear as two individual client devices, each with its own Media Access Control (MAC) address. This dual appearance for a single client device may causes a number of issues, for example, infrastructure resource issues, policy issues, and management issues.

Infrastructure resource issues may comprise the situation where each client device may consume twice as many entries (e.g., in Identity Services Engine (ISE) and other Remote Authentication Dial-In User Service (RADIUS) service). License fees may be set based on the number of connected client devices, thus the license needs may double. Policy issues may comprise the situation where the infrastructure may apply different policies based on the band, without the awareness that these different policies apply to the same client device (e.g., traffic on 2.4 GHz may be starved because it is expected to be the “garbage band”, while a client device relies on that band to fill gaps during a 5 GHz roam). Management issues may comprise the situation where Information technology (IT) support may not have visibility into the fact that two client devices are in fact the same device.

Wi-Fi 7 may implement MLO, but the implementation may only apply to single AP connections, thus it may not make dual Wi-Fi disappear. Thus there may be a need for a process to reconcile two MAC addresses and resolve them to a single client device. Embodiments of the disclosure may provide a process for a dual-Wi-Fi client device to associate to multiple APs while sharing a common identifier. The identifier may be used by infrastructure services to reconcile policies and identify multiple MAC addresses as representing a single client device.

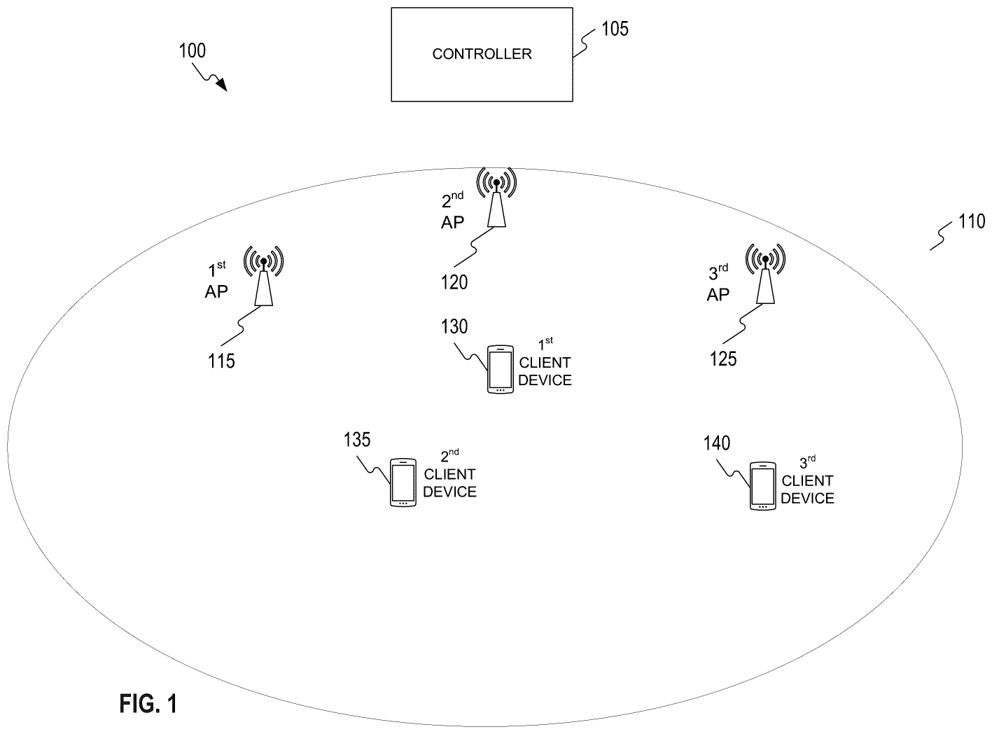

FIG. 1 shows an operating environment 100 for providing a client device identifier for dual-Wi-Fi connections. As shown in FIG. 1, operating environment 100 may comprise a controller 105 and a coverage environment 110. Coverage environment 110 may comprise, but is not limited to, a Wireless Local Area Network (WLAN) comprising a plurality of Access Points (APs) that may provide wireless network access (e.g., access to the WLAN for client devices). The plurality of APs may comprise a first AP 115, a second AP 120, a third AP 125. The plurality of APs may provide wireless network access to a plurality of client devices as they move within coverage environment 110. The plurality of client devices may comprise, but are not limited to, a first client device 130, a second client device 135, and a third client device 140. Ones of the plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, Virtual Reality (VR)/Augmented Reality (AR) devices, or other similar microcomputer-based device. Each of the plurality of APs may be compatible with specification standards such as, but not limited to, the Institute of Electrical and Electronics Engineers (IEEE) 802.11 specification standard for example.

The plurality of APs and the plurality of client devices may use Multi Link Operation (MLO) where they simultaneously transmit and receive across different bands and channels by establishing two or more links to two or more AP radios. These bands may comprise, but are not limited the 2 GHz band, the 5 GHz band, the 6 GHz band, and the 60 GHz band. The two or more links on any given one of the plurality of client devices may be made with any one AP or with any combination of the APs.

Controller 105 may comprise a Wireless Local Area Network controller (WLC) and may provision and control coverage environment 110 (e.g., a WLAN). Controller 105 may allow first client device 130, second client device 135, and third client device 140 to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide a client device identifier for dual-WiFi connections.

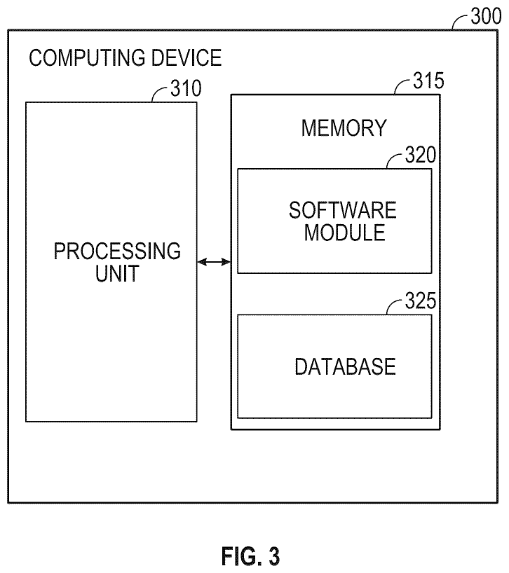

The elements described above of operating environment 100 (e.g., controller 105, first AP 115, second AP 120, third AP 125, first client device 130, second client device 135, or third client device 140) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 3, the elements of operating environment 100 may be practiced in a computing device 300.

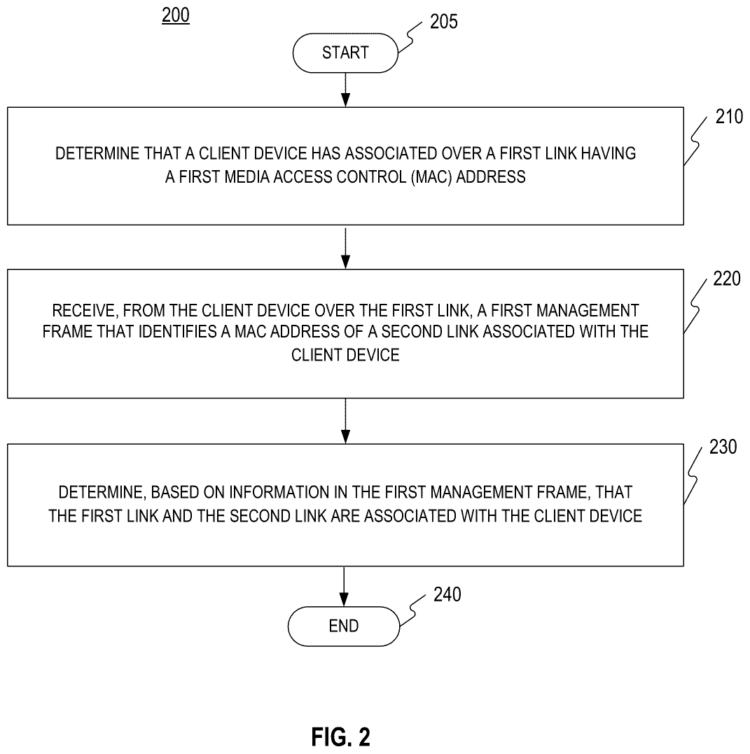

FIG. 2 is a flow chart setting forth the general stages involved in a method 200 consistent with embodiments of the disclosure providing a client device identifier for dual-Wi-Fi connections. Method 200 may be implemented using computing device 300 as described in more detail below with respect to FIG. 3. Computing device 300 may be embodied by controller 105. Ways to implement the stages of method 200 will be described in greater detail below.

Method 200 may begin at starting block 205 and proceed to stage 210 where computing device 300 (e.g., controller 105) may determine that first client device 130 has associated over a first link having a first Media Access Control (MAC) address. For example, first client device 130 may be capable of MLO and may use one of its radios to create the first link with first AP 115. A first secure tunnel may be established by this first link between first client device 130 and first AP 115.

From stage 210, where computing device 300 determines that first client device 130 has associated over the first link having the first MAC address, method 200 may advance to stage 220 where computing device 300 may receive, from first client device 130 over the first link, a first management frame that identifies a MAC address of a second link associated with first client device 130. For example, with a secure tunnel established with first AP 115, first client device 130 may send a management frame (type action) that includes the second link MAC address. The management frame may be sent unsolicited, for example, based on the observation that first AP 115 beacons/probe responses include a field/bit that may signal support for such feature. In another embodiment, first client device 130 and first AP 115 may enter a dialog over the secured tunnel (i.e., solicit). The dialog may include where either first client device 130 enquires about first AP 115's support for dual Wi-Fi, and sends the second link identifier (MAC) upon first AP 115's positive response. Or the dialog may include where first AP 115, having observed in the client device pre-association messages (e.g., association request) a field/bit that indicates first client device 130's support for dual Wi-Fi, queries first client device 130 for the second link MAC address. This stage may be repeated on the second link (when first client device 130 associates using the second link, it shares with first AP 115 the MAC address of the first link through the second link secured tunnel).

Once computing device 300 receives, from first client device 130 over the first link, the first management frame that identifies the MAC address of the second link associated with first client device 130 in stage 220, method 200 may continue to stage 230 where computing device 300 may determine, based on information in the first management frame, that the first link and the second link are associated with first client device 130. For example, the MACs/identifier (e.g., the MAC address of the first link and the MAC address of the second link) may be recognized by the plurality of APs and controller 105 as having a special significance for the client device identification. As such, the values may be shared with the relevant infrastructure services. On controller 105, both MACs may be treated as the same client device, and the client device page may reflect segments matching both connections. Thus the administrator may monitor or troubleshoot the client device as a whole, and configure the policies applied to the client device's links independently or together. Accordingly, the aforementioned infrastructure resource issues, policy issues, and management issues may be addressed. Once computing device 300 determines, based on information in the first management frame, that the first link and the second link are associated with first client device 130 in stage 230, method 200 may then end at stage 240.

In another embodiment, first client device 130 may associate on the first link. As a secure tunnel is established with first AP 115, first client device 130 may send a management frame (type action) that mentions a client device identifier. The client device identifier may comprise a blob that may take any form, including those envisioned by IEEE 802.11bh (arbitrary string, MAC, or other format). After first client device 130 associates on the second link, it also sends (over the second link secure tunnel) the client device identifier. Because the identifier is the same for both links, the infrastructure services recognize that it comes from a single client device.

Consistent with other embodiments of the disclosure, a probabilistic approach may be taken. For example, first client device 130 may use on both links MAC addresses that are close to each other. First client device 130 may use Randomized and Changing MAC (RCM) addresses to associate. For example, first client device 130 may generate two MAC addresses that differ from each other by a single or a few bits. In another embodiment, the difference between MACs may be known by the infrastructure, either because it is a convention between the client device and the AP vendor, or because the difference is standardized. Thus as the client device associates with MAC 1, then on the second link with MAC 2, both MACs may be shared with infrastructure services and the infrastructure services may recognize that both MACs represent a single client device.

When IEEE 802.1X is in use, the MACs/identifier may be passed to the RADIUS server as part of the Access-Request message. The MACs/identifier may be embedded in a Vendor Specific Attribute (VSA) or may reuse an existing field (e.g., Callback ID or other). The Remote Authentication Dial-In User Service (RADIUS) server may use this information to reconcile both calling station IDs, recognize a single client device, and thus possibly return a policy object that may apply to this scenario.

FIG. 3 shows computing device 300. As shown in FIG. 3, computing device 300 may include a processing unit 310 and a memory unit 315. Memory unit 315 may include a software module 320 and a database 325. While executing on processing unit 310, software module 320 may perform, for example, processes for providing a client device identifier for dual-Wi-Fi connections as described above with respect to FIG. 2. Computing device 300, for example, may provide an operating environment for controller 105, first AP 115, second AP 120, third AP 125, first client device 130, second client device 135, or third client device 140. Controller 105, first AP 115, second AP 120, third AP 125, first client device 130, second client device 135, or third client device 140 may operate in other environments and are not limited to computing device 300.

Computing device 300 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 300 may comprise any computer operating environment, such as hand-held devices, multiprocessor systems, microprocessor-based or programmable sender electronic devices, minicomputers, mainframe computers, and the like. Computing device 300 may also be practiced in distributed computing environments where tasks are performed by remote processing devices. The aforementioned systems and devices are examples, and computing device 300 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 300 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
determining that a client device has associated over a first link having a first Media Access Control (MAC) address;
receiving, from the client device over the first link, a first management frame that identifies a MAC address of a second link associated with the client device; and
determining, based on information in the first management frame, that the first link and the second link are associated with the client device.

2. The method of claim 1, wherein the first management frame is received over a first secured tunnel.

3. The method of claim 2, wherein the first management frame is received in response to a dialog between an Access Point and the client device over the first secured tunnel.

4. The method of claim 1, wherein the first management frame is received unsolicited.

5. The method of claim 1, further comprising:
determining that the client device has associated over a second link having the second MAC address; and
receiving, from the client device over the second link, a second management frame that identifies the MAC address of the second link associated with the client device.

6. The method of claim 5, wherein the second management frame is received over a second secured tunnel.

7. The method of claim 1, further comprising addressing, in response to determining that the first link and the second link are associated with the client device, at least one of an infrastructure resource issue, a policy issue, and a management issue.

8. A system comprising:
a memory storage; and
a processing unit coupled to the memory storage, wherein the processing unit is operative to:
determine that a client device has associated over a first link having a first Media Access Control (MAC) address;
receive, from the client device over the first link, a first management frame that identifies a MAC address of a second link associated with the client device; and
determine, based on information in the first management frame, that the first link and the second link are associated with the client device.

9. The system of claim 8, wherein the first management frame is received over a first secured tunnel.

10. The system of claim 9, wherein the first management frame is received in response to a dialog between an Access Point and the client device over the first secured tunnel.

11. The system of claim 8, wherein the first management frame is received unsolicited.

12. The system of claim 8, wherein the processing unit is further operative to:
determine that the client device has associated over a second link having the second MAC address; and
receive, from the client device over the second link, a second management frame that identifies the MAC address of the second link associated with the client device.

13. The system of claim 12, wherein the second management frame is received over a second secured tunnel.

14. A non-transitory computer-readable medium that stores a set of instructions which when executed perform a method executed by the set of instructions comprising:
determining that a client device has associated over a first link having a first Media Access Control (MAC) address;
receiving, from the client device over the first link, a first management frame that identifies a MAC address of a second link associated with the client device; and
determining, based on information in the first management frame, that the first link and the second link are associated with the client device.

15. The non-transitory computer-readable medium of claim 14, wherein the first management frame is received over a first secured tunnel.

16. The non-transitory computer-readable medium of claim 15, wherein the first management frame is received in response to a dialog between an Access Point and the client device over the first secured tunnel.

17. The non-transitory computer-readable medium of claim 14, wherein the first management frame is received unsolicited.

18. The non-transitory computer-readable medium of claim 14, further comprising:
determining that the client device has associated over a second link having the second MAC address; and
receiving, from the client device over the second link, a second management frame that identifies the MAC address of the second link associated with the client device.

19. The non-transitory computer-readable medium of claim 18, wherein the second management frame is received over a second secured tunnel.

20. The non-transitory computer-readable medium of claim 14, further comprising addressing, in response to determining that the first link and the second link are associated with the client device, at least one of an infrastructure resource issue, a policy issue, and a management issue.
